(19) United States
(12) Patent Application Publication
(10) Pub. No.: US 2005/0122279 A1
(43) Pub. Date: Jun. 9, 2005

(54) Method of warming up a display device

(75) Inventors: Shih-Hua Tseng, Taipei City (TW); Kuen-Long Lee, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/962,571

(22) Filed: Oct. 13, 2004

(30) Foreign Application Priority Data
Dec. 5, 2003 (TW) 092134440

(51) Int. Cl. G09G 1/06; G09G 3/36

(52) U.S. Cl. 345/10

(57) ABSTRACT

A method of warming up a display device is performed by pressing at least one adjustment button placed on the front panel of the display device. When the adjustment button is pressed an image pattern is displayed so that the display device can perform the warming up process. The image signal is generated by an OSD controller within a CRT display device or a scalar within an LCD display device, so the display device does not need to connect to an image output device during the warming up process and the cost and time involved are accordingly both low.

### BACKGROUND OF THE INVENTION

1. Field of the Invention

The present invention relates to a method of warming up a display device and, more particularly, to a method of warming up a display device without inputting a test signal.

2. Description of the Related Art

Both cathode-ray tube (CRTs) displays and liquid crystal displays (LCDs) need to perform a warming up process for quality examination during manufacture, to ensure that each displayer can display an image pattern precisely. The color saturation of the display image pattern will be stable after a warming up period (for example, 20 minutes), and then a technician performs a modification of display parameters to correct the color of the display image pattern. Since different display devices have different structures, they require different warming up methods.

As shown in FIG. 1, a CRT display device 10 has a power button 12 and a plurality of adjustment buttons on a front panel; the power button 12 is used for turning the cathode-ray tube 10 on or off, and the plurality of adjustment buttons 14 are used for calling up an on screen display (OSD) interface to adjust the display parameters.

As shown in FIG. 2, a video signal input interface 21 of the CRT display device 10 is used for inputting an image signal and outputting the image signal to a microprocessor 22 and an OSD controller 25 respectively. A memory 23 is used for storing display parameters, and the microprocessor 22 generates an image pattern according to the display parameters and the image signal, and utilizes a synchronous process chip 24, a vertical deflection controller 27, a horizontal deflection controller 28 and a display driver 29 to drive the cathode-ray tube for displaying the image pattern on the screen. The OSD controller 25 is triggered by the adjustment buttons 14 and utilizes an amplifier 26 to output an OSD signal to the display driver 29 so as to display the OSD interface on the screen. When the CRT display device 10 is to perform a warming up process, the CRT display device 10 inputs the image signal to generate the image pattern; if the video signal input interface 21 does not input any image signal, the CRT display device 10 switches into a power-saving mode, such as idle mode or sleep mode, and will cease the warming up process.

As shown in FIG. 3, a video signal input interface 31 of an LCD display device 30 inputs the image signal and outputs the image signal to a microprocessor 32 and a scalar 34 respectively. A memory 33 is used for storing display parameters, and the microprocessor 22 generates an image pattern according to the display parameters and the image signal, and utilizes the scalar 34 and a display driver 35 to drive a display panel to display the image pattern. When the LCD display device 30 is to perform a warming up process, the video signal input interface 31 inputs the image signal to generate the image pattern; if the video signal input interface 31 did not input the image signal, the LCD display device 30 will switch into a power-saving mode, such as idle mode or sleep mode, and will cease the warming up process.

Therefore, both display devices require an image signal to be input into the video signal input interface 21 or 31 to generate the image pattern to perform the warming up process. During the manufacturing step for either of the display devices, only a few images output devices (such as computer) are available. If every display device must be connected to the image output devices for 20 minutes, a great deal of time is wasted.

Therefore, it is desirable to provide a method of warming up a display device to mitigate and/or obviate the aforementioned problems.

### SUMMARY OF THE INVENTION

A main objective of the present invention is to provide a method of warming up a display device so that the display device can perform a warm up process without an image signal.

Another objective of the present invention is to provide a method of warming up a display device, which avoids long warm up time that otherwise reduce the lifetime of the display device.

In order to achieve the above-mentioned objectives, there is at least one adjustment button placed on the display device, the at least one adjustment button is used for calling up a visual adjusting display interface and setting a display parameter, the method comprises: (A) turning on the display device; (B) determining if the at least one button is pressed; if the at least one button is not pressed, step (F) is next performed; (C) determining if an image signal is input; if there is no image signal input, step (E) is next performed; (D) utilizing a display driving circuit to output an image to a display device, and then performing step (C); and (E) calling the visual adjusting display interface to set up a display parameter corresponding to the image; wherein the image is output by a visual adjusting display control center, the image signal is provided by an image output device, and the display device driving circuit is used for driving the display device to display the image.

Another method of the present invention comprises: (A) switching on the display device; (B) determining if the at least one button is pressed; if the at least one button is not pressed, the method is ceased; and (C) outputting an image to a display driving circuit; wherein the image is output by a visual adjusting display control center, and the display driving circuit is used for driving the display device to display the image.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a CRT display device;

FIG. 2 is a functional block drawing of the CRT display device;

FIG. 3 is a functional block drawing of a liquid crystal display; and

FIG. 4 is a flowchart of the method of warming up the display device according to the present invention.

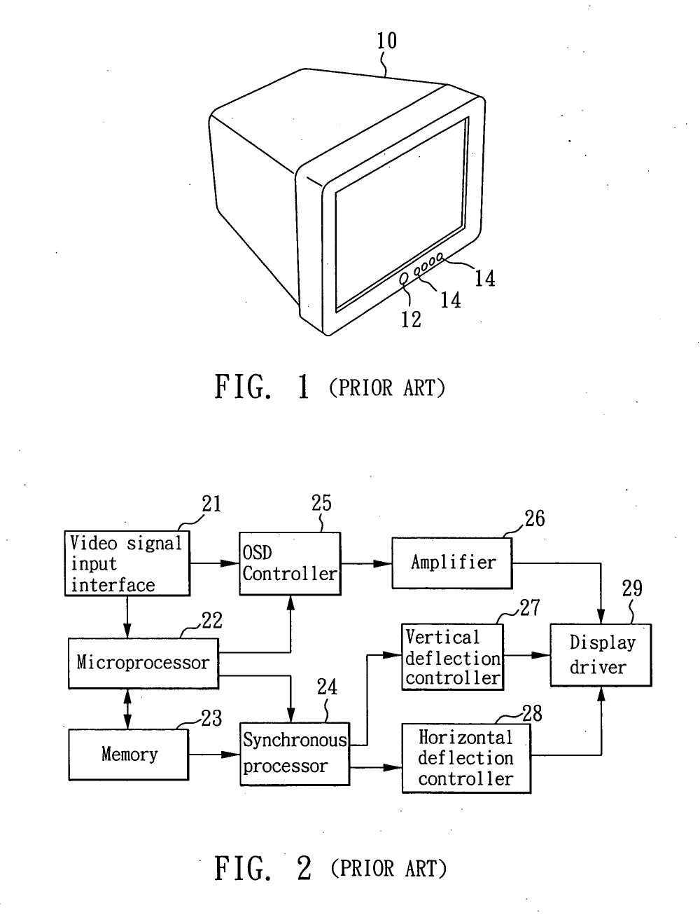

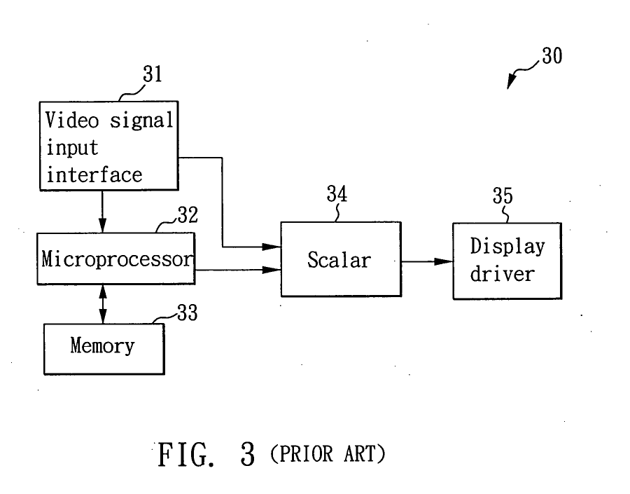

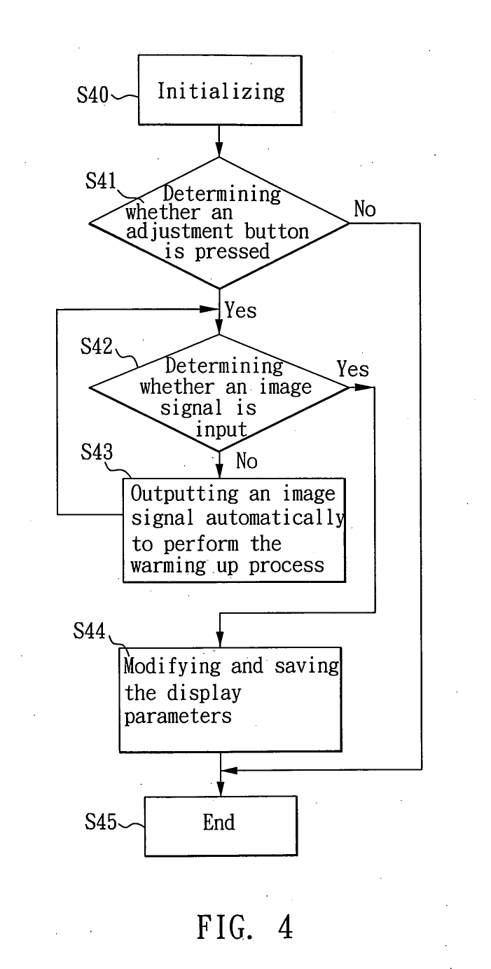

### DETAILED DESCRIPTION OF THE PREFERRED EMBODIMENT

The method of warming up the display device (either the CRT display device 10 or the LCD display device 30) according to the present invention requires no input image signal; the OSD controller 25 or the image dimension processor 34 outputs the image signal automatically according to an instruction from the microprocessor 22 or 32, and then the driving circuit 29 or 35 drives the cathode-ray tube or the display panel to display an image pattern. Since the display device displays the image pattern according to the image signal, the display device performs the warming up process. In the present invention, the warming up process can be initiated by appropriate pressing of one of the adjustment buttons 14; for example, by continuously pressing one of the adjustment buttons 14 for 5 seconds, or by pressing two or more adjustment buttons 14 at the same time, so that the microprocessor 22 or 32 will be triggered and then the display device will perform the warming up process. Therefore, the method of warming up the display device not only saves on warming up time, but also saves on the manufacturing costs of the image output device. The method of warming up the display device comprises the following steps:

Step S40: initializing. After the display device is turned on, the user decides whether the display device should perform the warming up process or switch to the power-saving mode.

Step S41: determining whether an adjustment button 14 is pressed; if the user presses at least one adjustment button 14, the microprocessor 22 or 32 will output an instruction to perform the warming up process; otherwise, the display device will enter into the normal mode and step S45 is performed. During the warming up process, the OSD controller 25 or the image dimension processor 34 generates an image signal automatically according to the command from the microprocessor 22 or 32, and then the screen or the display panel will display the image pattern corresponding to the image signal. In the normal mode, when the image output device outputs the image signal, the display device generates the image pattern corresponding to the image signal; if the image output device does not output an image signal, the display device will switch into the power-saving mode to save the power. The switching process, however, is not the purpose of the present invention, and so no further description will be provided.

Step S42: determining whether an image signal is input. The image output device outputs the image signal to the display device so that the display device displays the image pattern. When the image output device outputs the image signal to the display device, step S44 is performed next; otherwise, step S43 is next performed.

Step S43: outputting the image signal automatically to perform the warming up process. Since the triggered microprocessor 22 or 32 outputs the instruction the OSD controller 25 or the scalar 34, the image pattern driven by the driving circuit 29 or 35 corresponds to the image signal and is displayed on the screen or the display panel. The image pattern can be a red block, a blue block, a green block, a white block or a combination of the above blocks. The image pattern also can change its position, shape, or color with time, and then step S42 is re-performed.

Step S44: modifying and saving the display parameters. When the image output device outputs the image signal to the display device, the display device performs the warming up process for a period and the color saturation becomes more and more stable, so the technician modifies the display parameters precisely and saves the modified display parameters in the memory 23 or 33 via the OSD interface. The display parameters include image color, image position, image size and so on.

Step S45: end.

Another embodiment to warm up a display is also applicable to execute the above steps of the first embodiment in addition to the steps S42 and S44, so that this second embodiment has only steps S40, S41, S43 and S45. The only difference between the two embodiments is whether the display parameters are provided for adjustment; when the display device manufacturer needs no more additional display parameter adjustment, the second embodiment is preferable.

Although the present invention has been explained in relation to its preferred embodiment, it is to be understood that many other possible modifications and variations can be made without departing from the spirit and scope of the invention as hereinafter claimed.

1. A method of warming up a display device, at least one adjustment button placed on the display device and a plurality of display parameters are modified via a visual adjustment interface, the method comprising:
(A) initializing;
(B) determining whether the adjustment button is pressed; if the button is pressed, step (C) is next performed;
(C) determining whether an image signal is input; if there is no image signal input, step (E) is next performed;
(D) outputting an image signal automatically to perform a warming up process, and then performing step (C); and
(E) modifying and saving the display parameters;
wherein the image signal is output from a visual adjustment device and obtained by a display driver, and then the display driver drives the display device to display an image pattern corresponding to the image signal.

2. The method as claimed in claim 1, wherein the image signal in step (C) is provided by a computer.

3. The method as claimed in claim 1, wherein the image pattern is a red block, a blue block, a green block, a white block or a combination of the aforementioned blocks.

4. The method as claimed in claim 1, wherein a position, shape, or color of the image pattern changes with time.

5. The method as claimed in claim 1, wherein the display device is a CRT display device, the visual adjustment interface is an OSD interface, and the visual adjustment device is an OSD controller.

6. A method of warming up a display device, at least one adjustment button placed on the display device and a plurality of display parameters are modified via a visual adjustment interface, the method comprising:
(A) initializing;
(B) determining whether the adjustment button is pressed; if the button is not pressed, the method is ceased; and
(C) outputting an image signal automatically to perform a warming up process;
wherein the image signal is output from a visual adjustment device and obtained by a display driver, and then the display driver drives the display device to display an image pattern corresponding to the image signal.

7. The method as claimed in claim 6, wherein an image signal in step (B) is provided by a computer.

8. The method as claimed in claim 6, wherein the image pattern is a red block, a blue block, a green block, a white block or a combination of the aforementioned blocks.

9. The method as claimed in claim 6, wherein a position, shape, or color of the image pattern changes with time.

10. A method of warming up a display device, at least one adjustment button placed on the display device and a plurality of display parameters are modified via a visual adjustment interface, the method comprising:
(A) initializing;
(B) determining whether the adjustment button is pressed; if the button is pressed, step (E) is next performed;
(C) determining whether an image signal is input; if there is no image signal input, step (E) is next performed;
(D) outputting an image signal automatically to perform a warming up process, and then performing step (C); and
(E) modifying and saving the display parameters;
wherein the image signal is output from a scalar and obtained by a display driver, and then the display driver drives the display device to display an image pattern corresponding to the image signal.

11. The method as claimed in claim 10, wherein the image signal in step (C) is provided by a computer.

12. The method as claimed in claim 10, wherein the image pattern is a red block, a blue block, a green block, a white block or a combination of the aforementioned blocks.

13. The method as claimed in claim 10, wherein a position, shape, or color of the image pattern changes with time.

14. The method as claimed in claim 10, wherein the display device is a LCD display device, and the visual adjustment interface is an OSD interface.

15. A method of warming up a display device, at least one adjustment button placed on the display device and a plurality of display parameters are modified via a visual adjustment interface, the method comprising:
(A) initializing;
(B) determining whether the adjustment button is pressed; if the button is pressed, step (C) is next performed; and
(C) outputting an image signal automatically to perform a warming up process;
wherein the image signal is output from a scalar and obtained by a display driver, and then the display driver drives the display device to display an image pattern corresponding to the image signal.

16. The method as claimed in claim 15, wherein the image pattern is a red block, a blue block, a green block, a white block or a combination of the aforementioned blocks.

17. The method as claimed in claim 15, wherein a position, shape, or color of the image pattern changes with time.
